(19) United States
(12) Patent Application Publication
(10) Pub. No.: US 2025/0033793 A1
(43) Pub. Date: Jan. 30, 2025

(54) Interaction system in the cockpit of an aircraft and an associated interaction method

(71) Applicant: THALES, Meudon (FR)

(72) Inventors: François LEULLIER, MERIGNAC (FR); Thierry CHABAUD, MERIGNAC (FR)

(21) Appl. No.: 18/781,078

(22) Filed: Jul. 23, 2024

(30) Foreign Application Priority Data
Jul. 26, 2023 (FR) 2308058

(51) Int. Cl. B64D 43/00; G06F 3/14; G06T 11/20

(52) U.S. Cl. CPC B64D 43/00; G06F 3/14; G06T 11/206

(57) ABSTRACT

An interaction system in the cockpit of an aircraft for controlling at least one avionics system with setting values, including a setting medium configured to generate a setting signal corresponding to a setting value selected by an operator following a first action, and a validation signal corresponding to a validation of the selected setting value following a second action, a display module configured to display the selected setting value and to generate a feedback signal including a graphic signature of the displayed setting value, and a processing module configured to receive each feedback signal and each validation signal, to detect each modification in the setting value and to verify that each detected modification corresponds to a validation signal.

### CROSS-REFERENCE TO RELATED APPLICATION

This application is a U.S. non-provisional application claiming the benefit of French Application No. 23 08058, filed on Jul. 26, 2023, which is incorporated herein by reference in its entirety.

### TECHNICAL FIELD OF THE INVENTION

The present invention relates to an interaction system in the cockpit of an aircraft. The present invention also relates to an associated interaction method.

The invention relates in particular to securing interactions for Human Machine Interfaces (HMI) for critical avionics systems, such as aircraft cockpits. By critical interaction, here we mean any interaction the inadvertent activation of which, unperceived by the crew, is a failure condition the impact of which on the system is HAZARDOUS or CATASTROPHIC, such as defined, for example, by standard AC 25.1309-1.

### BACKGROUND OF THE INVENTION

As is well known, the setting of a large number of critical avionics systems are performed by the pilot or any other operator, by selecting a setting value for such a system. In some cases, an additional validation step is required to validate the selection of the operator.

Clearly, any inadvertent modification to the selected value can lead to serious consequences for flight safety. For critical avionics systems, these consequences are categorized as HAZARDOUS or CATASTROPHIC.

An inadvertent modification in the selected value can occur, for example, as a result of an avionics system failure.

### SUMMARY OF THE INVENTION

The aim of the invention is therefore to ensure that any inadvertent modification of the setting, linked to a system failure, is detected and passed on to the operator. To this end, the invention has as its object an interaction system in the cockpit of an aircraft for controlling at least one avionics system with setting values, the interaction system.

This system comprises a setting medium for the setting values associated with said avionics system, the setting medium being configured to generate a setting signal corresponding to a setting value selected by an operator following a first action, and a validation signal corresponding to a validation of the selected setting value following a second action by the operator; a display module configured to display the selected setting value and to generate a feedback signal comprising a graphic signature of the setting value displayed; a processing module configured to receive each feedback signal from the display module and each validation signal from the setting medium, to detect each modification of the setting value and to verify that each detected modification of the setting value corresponds to a validation signal.

Equipped with these features, the interaction system according to the invention allows any setting of the setting values associated with an avionics system to be secured. In particular, when a setting value is modified without a validation command performed by the operator, an inconsistency is detected and can be passed back to the operator. This inconsistency can be passed back to the operator in any suitable form in order to draw his attention. This is advantageous relative to a simple change in the display of the modified value (for example, by temporary flashing and/or underlining) which may go unnoticed by the operator, particularly when such a change is of limited duration.

According to other advantageous aspects of the invention, the interaction system comprises one or more of the following features, taken individually or in any technically possible combination:
the processing module is further configured to issue an alert when a detected modification in the setting value does not correspond to any validation signal;
the setting medium can be allocated to set the setting values associated with different avionics systems;
the setting medium is a rotator, advantageously a multifunction rotator;
the first action corresponds to a rotation of the rotator;
the second action corresponding to an action other than rotation of the rotator, in particular pressing on the rotator;
the setting signal and the validation signal are generated and transmitted by the setting medium in a segregated manner:
the graphic signature of the displayed setting value is generated by an analysis of pixels representing the setting value displayed by the display module;
a first control chain and a first monitoring chain;
the display module being integrated into the first control chain and the processing module being integrated into the first monitoring chain;
a second control chain and a second monitoring chain;
the second monitoring chain being configured to receive the validation signal for controlling a setting value displayed by the second control chain; and
the validation signal presents a discrete signal.

The invention also relates to an interaction method in the cockpit of an aircraft to control at least one avionics system with setting values.

The method comprises the following steps:
generating, by a setting medium, a setting signal corresponding to a setting value selected by an operator following a first action, and a validation signal corresponding to a validation of the selected setting value following a second action by the operator;
displaying the selected setting value by a display module;
generating a feedback signal comprising a graphic signature of the displayed setting value;
receiving each feedback signal from the display module and each validation signal from the setting medium;
detecting each change in the setting value; and
verifying that each detected modification of the setting value corresponds to a validation signal.

The invention also relates to a computer program product including software instructions which, when executed by a computer, implement the method as defined above.

### BRIEF DESCRIPTION OF THE DRAWINGS

The invention will become clearer on reading the following description, given solely by way of non-limiting example, and made with reference to the drawings in which:

FIG. 1 is a schematic view of an interaction system according to a first embodiment of the invention;

FIG. 2 is a schematic view of an interaction system according to a second embodiment of the invention; and

FIG. 3 is a flow chart of an interaction method according to the invention; the interaction method being implemented by the interaction system of FIG. 1 or FIG. 2.

### DETAILED DESCRIPTION

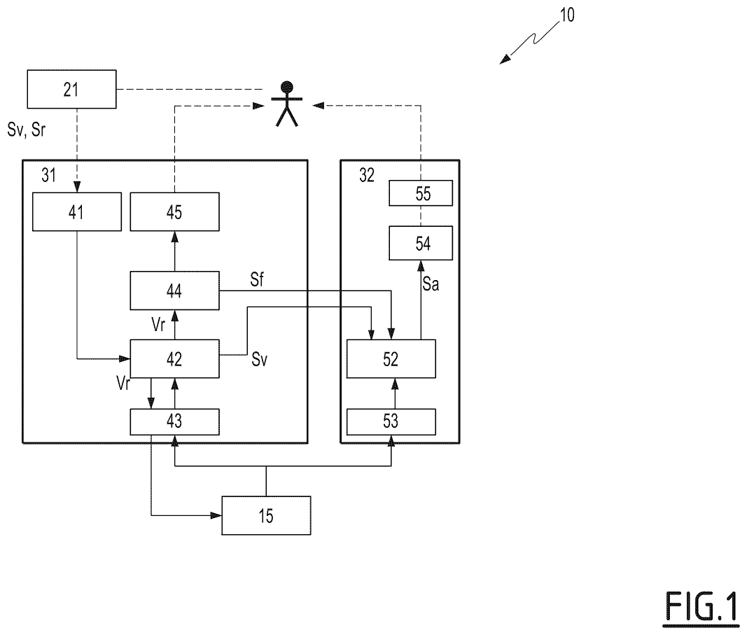

FIG. 1 shows an interaction system 10 according to a first embodiment of the invention.

This interaction system 10 is installed in an aircraft cockpit. By “cockpit” we mean the area from which the aircraft is piloted by one or more operators. Thus, according to one example, the cockpit is part of the aircraft, and the aircraft presents, for example, a plane or a helicopter. In this case, the or each operator is a pilot. According to another example, the cockpit is remote from the aircraft, which presents, for example, a drone. In this case, the aircraft is piloted remotely by one or more operators.

The interaction system 10 allows the operator to interact with at least one avionics system 15. In particular, the interaction system 10 allows such a system to be controlled by setting values, as will be explained in greater detail later.

Advantageously, the interaction system 10 allows the operator to interact with a plurality of avionics systems 15.

The or each avionics system 15 is chosen, for example, from the list comprising:
an autopilot;
a navigation system (such as a GNSS system, an inertial unit, etc.);
a radar (anti-collision, weather, etc.);
a navigation instrument (altimeter, variometer, etc.);
a hydraulic and/or electrical powertrain management system; and
a mission planning system.

The or each avionics system 15 is at least partially controlled by the interaction system 10 using setting values able to be selected by the operator.

A setting value then corresponds to the value of a particular setting parameter of the avionics system 15, allowing it to be at least partially controlled.

For example, when the avionics system 15 is an altimeter, the setting parameter may present a baro-correction. In this case, the setting value then corresponds to a baro-correction value able to be selected by the operator as a function of weather conditions.

To select a setting value for the corresponding avionics system 15, the interaction system 10 comprises a setting medium 21. This setting media 21 is, for example, permanently associated with the corresponding avionics system 15. According to another embodiment, the setting medium 21 can be allocated to this system 15. In this latter case, the setting medium 21 can also be allocated to at least one other avionics system 15 by the operator or by another system. For example, in some cases, before actuating the setting medium 21 to select a setting value, the operator can first select the avionics system 15 for which the setting is to be applied. This selection is made, for example, from the setting medium 21 or from any other available device (including a touch-sensitive device).

The operator can operate the setting medium 21 by means of a first action to select a setting value and a second action to validate this selection. The second action is different from the first action.

The setting medium 21 is configured to generate a setting signal Sr following the first action and a validation signal Sv following the second action.

In particular, the setting signal Sr allows to describe the first action performed by the operator in order to deduce the setting value selected by the operator. This signal may, for example, present an electromagnetic wave encoding this first action.

The validation signal Sv allows to encode the fact that validation of the selected value has taken place. For example, this validation signal Sv presents a discrete signal equal to “1” when a second action is performed and “0” in all other cases.

Advantageously, the setting medium 21 is configured to generate and transmit the setting signal Sr and the validation signal Sv in a segregated manner.

Advantageously, the setting medium 21 presents a rotator. In such a case, the first action corresponds to a rotation of the rotator and the second action corresponds, for example, to pressing on the rotator.

More advantageously, the rotator is a multifunction rotator. In other words, the rotator can be allocated to different avionics systems, as explained above.

According to the first embodiment shown in FIG. 1, the interaction system 10 presents a “Smart Display” architecture known per se.

According to this architecture, the interaction system 10 comprises a first control chain 31 and a first monitoring chain 32 allowing to monitor the operation of the first control chain 31. The first control chain 31 therefore corresponds to the English designation “COM” (from the English “COMMAND”) and the first monitoring chain 32 corresponds to the English designation “MON” (from the English “MONITORING”). Advantageously, the first monitoring chain 32 is implemented differently from the first control chain 31.

The first control chain 31 comprises an acquisition module 41 connected to the setting medium 21 and able to acquire the signals Sr, Sv from this medium 21, a processing module 42 able to process the acquired signals, an I/O module 43 connected to the or each avionics system 15, a display module 44 able to generate graphic images from the data processed by the processing module 42 and a screen 45 able to display the images generated by the display module 44.

In particular, the processing module 42 is able to receive the setting signal Sr acquired by the acquisition module 41 to deduce the setting value Vr selected by the operator. The processing module 42 is also able to transmit this value Vr to the corresponding avionics system 15 by means of the I/O module 43 and to the display module 44. The processing module 42 is also able to receive the validation signal Sv acquired by the acquisition module 41 and transmit it to the first monitoring chain 32.

In some examples, the acquisition module 41 or the processing module 42 is able to protect the validation signal Sv by adding a CRC code, for example.

The display module 44 is able to generate a graphic image corresponding to the selected setting value Vr and display it on the screen 45. The display module 44 is also able to generate a feedback signal Sf comprising a graphic signature of the setting value displayed on the screen 45. This graphic signature of the setting value displayed is generated, for example, by an analysis of pixels representing the setting value displayed. The display module 44 is also able to send this signal to the first monitoring chain 32.

The first monitoring chain 32 has a structure similar to that of the first control chain 31 and comprises in particular a processing module 52, an I/O module 53, a display module 54 and a screen 55.

The processing module 52 of the first monitoring chain 32 is able to receive the validation signal Sv and the feedback signal Sf transmitted by the first control chain 31. The processing module 52 of the first monitoring chain 32 is also able to analyze the feedback signal Sf to detect any modification in the setting value and, when such a modification is detected, to verify that such a modification corresponds to a received validation signal Sv.

When such verification is not successful, the processing module 52 of the first monitoring chain 32 is able to generate an alert signal Sa. This alert signal Sa is intended to be communicated to the operator, for example by means of at least one of the displays 45 or 55, or in any other suitable form (sound, touch, etc.).

The modules 42 to 44 and 52 to 54 of the chains 31, 32 are able to implement other functionalities of the interaction system 10. These other functionalities are known per se and will not be described hereafter.

In addition, each of these modules 42 to 44 and 52 to 54 is, for example, implemented as software and/or at least partially as a programmable logic component, such as an FPGA (Field Programmable Gate Array), or an integrated circuit, such as an ASIC (Application Specific Integrated Circuit). Furthermore, each of the processing modules 42, 52 may correspond to a CPU, and each of the display modules 44, 54 may correspond to a GPU.

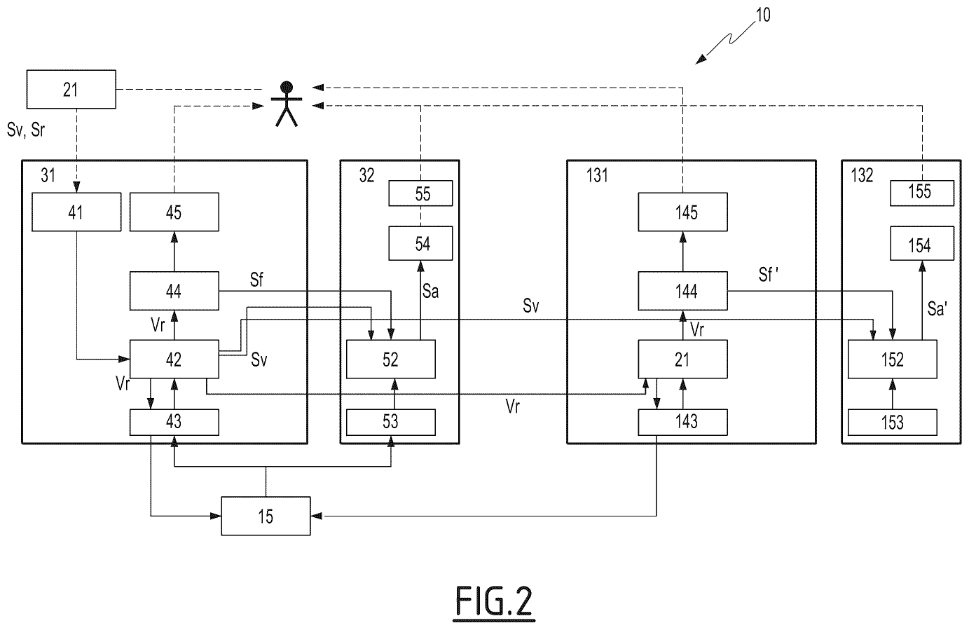

FIG. 2 illustrates the interaction system 10 according to a second embodiment. According to this embodiment, the interaction system 10 comprises the setting medium 21, the first control chain 31 and the first monitoring chain 32, such as described above. In addition, as in the previous case, the interaction system 10 allows one or more avionics systems 15 to be controlled with setting values.

According to the second embodiment, the interaction system 10 presents two display chains in parallel. Thus, the interaction system 10 also comprises a second “COM”-type control chain 131 and a second “MON”-type monitoring chain 132.

Each of these chains 131, 132 comprises the modules 142 to 144 and the modules 152 to 154 similar to the modules 42 to 44 and the modules 52 to 54 respectively of the first control chain 31 and the first monitoring chain 32. In addition, each of these chains 131, 132 further comprises a display 145, 155.

In addition to the functionalities described in relation to the first embodiment, the processing module 42 of the first control chain 31 is able to transmit the value Vr selected by the operator to the processing module 142 of the second control chain 131 and the validation signal Sv to the processing module 152 of the second monitoring chain 132.

The processing module 142 of the second control chain 131 is then able to synchronize this setting value Vr with its setting value and transmit this synchronized value to the display module 144 of the second control chain 131.

The display module 144 of the second control chain 131 is then able to display the synchronized value on the screen 145 and generate a feedback signal Sf′ comprising a graphic signature of the setting value displayed on the screen 145.

The processing module 152 of the second monitoring chain 132 is able to receive the validation signal Sv from the processing module 42 of the first control chain 31 and the feedback signal Sf′ from the display module 144 of the second control chain 131, to verify the consistency of these signals as previously described. Thus, when a modification of the setting value Vr does not correspond to any validation signal Sv, the processing module 152 of the second monitoring chain 132 is able to emit an alert signal Sa′ intended to be transmitted to the operator.

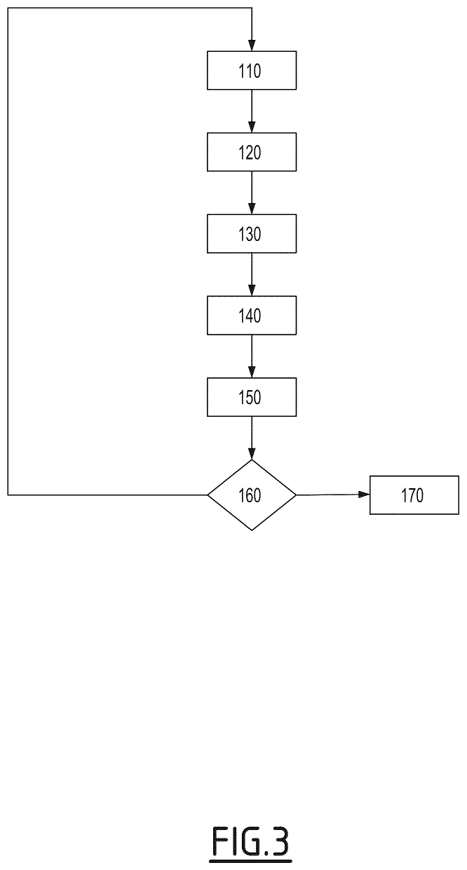

The interaction process 100 according to the invention will now be described with reference to FIG. 3, presenting a flowchart of its steps. This process is implemented by the interaction system 10, described above in relation to one of the embodiments.

Initially, it is considered that the control medium 21 is associated with one of the avionics systems 15. In addition, the operation of this avionics system 15 is defined by at least one control parameter with a specific setting value. This setting value presents, for example, a default value or a value previously chosen by the operator.

During a first step 110, the operator performs a first action on the setting medium 21 to select a new setting value. Once selected, the operator performs a second action on this setting medium 21 to validate his selection.

The setting medium 21 therefore generates a setting signal Sr corresponding to the selected setting value, and a validation signal Sv corresponding to the validation of the selected setting value.

During the next step 120, the processing module 42, 142 of one of the control chains 31, 131 or of each control chain 31, 131 determines the selected setting value Vr from the received setting signal Sr. The selected setting value Vr is then displayed on at least one of the screens. This is done, for example, by the display module 44, 144 of one of the control chains 31, 131 or of each control chain 31, 131.

During the next step 130, the corresponding display module 44, 144 generates a feedback signal Sf, Sf′ comprising a graphic signature of the displayed setting value.

During the next step 140, the processing module 52, 152 of one of the monitoring chains 32, 132 or of each monitoring chain 32, 132 receives the feedback signal Sf, Sf′ from the corresponding display module 44, 144 and each validation signal Sv from the setting medium 21.

During the next step 150, the processing module 52, 152 of one of the monitoring chains 32, 132 or of each monitoring chain 32, 132 detects each modification in the setting value Vr.

During the next step 160, the processing module 52, 152 of one of the monitoring chains 32, 132 or of each monitoring chain 32, 132 verifies that each detected modification in the setting value Vr corresponds to a validation signal Sv.

If this is the case, the procedure is therefore repeated for each new modification in the setting value Vr.

If at least one detected modification does not correspond to any validation signal, the corresponding processing module 52, 152 issues an alarm signal Sa, Sa′ during a step 170.

The invention therefore presents a number of advantages.

First of all, as explained above, the invention allows each inadvertent modification of a setting value to be detected and to warn the operator with certainty.

Moreover, the invention uses “COM”-“MON” architecture, which ensures the required level of criticality. Furthermore, the invention can be easily integrated into an existing architecture without significant modification.

Finally, the invention can be applied to different types of control medium, which may possibly be allocated to different avionics systems. For example, the use of a multifunction rotator is particularly advantageous in the context of the invention.

Of course, the invention remains applicable to other interaction system architectures. For example, such an architecture may have a single processing chain and not necessarily at least two of the “MON” and “COM” type as previously described.

1. An interaction system in the cockpit of an aircraft controlling at least one avionics system with setting values, the interaction system comprising:
a setting medium setting values associated with the at least one avionics system, the setting medium generating a setting signal corresponding to a setting value selected by an operator following a first action, and a validation signal corresponding to validation of the selected setting value following a second action by the operator;
a display module displaying the selected setting value and generating a feedback signal comprising a graphic signature of the setting value displayed; and
a processing module receiving each feedback signal from said display module and each validation signal from said setting medium, detecting each modification in the setting value and verifying that each detected modification in the setting value corresponds to a validation signal.

2. The interaction system according to claim 1, wherein said processing module issues an alert when a detected modification in the setting value does not correspond to any validation signal.

3. The interaction system according to claim 1, wherein said setting medium sets the setting values associated with different avionics systems.

4. The interaction system according to claim 1, wherein said setting medium comprises a rotator, wherein the first action corresponds to a rotation of said rotator, and wherein the second action corresponds to an action other than rotation of said rotator.

5. The interaction system according to claim 4, wherein said setting medium comprises a multifunction rotator.

6. The interaction system according to claim 4, wherein the second action corresponds to press on said rotator.

7. The interaction system according to claim 1, wherein the setting signal and the validation signal are generated and transmitted by said setting medium in a segregated manner.

8. The interaction system according to claim 1, wherein the graphic signature of the displayed setting value is generated by an analysis of pixels representing the setting value displayed by said display module.

9. The interaction system according to claim 1, further comprising a first control chain and a first monitoring chain, wherein said display module is integrated in said first control chain and wherein said processing module is integrated in said first monitoring chain.

10. The interaction system according to claim 9, further comprising a second control chain and a second monitoring chain, said second monitoring chain receiving the validation signal to control a setting value displayed by said second control chain.

11. The interaction system according to claim 1, wherein the validation signal presents a discrete signal.

12. An interaction method in the cockpit of an aircraft to control at least one avionics system with setting values, the method comprising:
generating by a setting medium a setting signal corresponding to a setting value selected by an operator following a first action, and a validation signal corresponding to a validation of the selected setting value following a second action by the operator;
displaying the setting value selected by a display module;
generating a feedback signal comprising a graphic signature of the displayed setting value;
receiving each feedback signal from the display module and each validation signal from the setting medium;
detecting each modification in the setting value; and
verifying that each detected modification of the setting value corresponds to a validation signal.
